(19) United States
(12) Patent Application Publication
(10) Pub. No.: US 2022/0101235 A1
(43) Pub. Date: Mar. 31, 2022

(54) AUTOMATED, INTEGRATED AND COMPLETE COMPUTER PROGRAM/PROJECT MANAGEMENT SOLUTIONS STANDARDIZES AND OPTIMIZES MANAGEMENT PROCESSES AND PROCEDURES UTILIZING CUSTOMIZABLE AND FLEXIBLE SYSTEMS AND METHODS

(71) Applicant: Salim B. KHALIL, Riverside, CA (US)

(72) Inventor: Salim B. KHALIL, Riverside, CA (US)

(21) Appl. No.: 17/545,181

(22) Filed: Dec. 8, 2021

Related U.S. Application Data
(63) Continuation-in-part of application No. 16/366,809, filed on Mar. 27, 2019, now abandoned.
Application No. 16/366,809 is a continuation-in-part of application No. 15/231,608, filed on Aug. 8, 2016, now abandoned.
(60) Provisional application No. 62/208,670, filed on Aug. 22, 2015.

(51) Int. Cl. G06Q 10/06; G06Q 30/08

(52) U.S. Cl. CPC G06Q 10/06315; G06Q 30/08; G06Q 50/30; G06Q 10/0635; G06Q 10/063114

(57) ABSTRACT

Embodiments are computer program product that provides systems and methods as a complete solution for management profession from initiation to closeout; complies with industry standards and requirements. Automated functionality through cloud-based server, standardized combination of database management systems with five main user interfaces with an additional (extended) two user interfaces for post project completion during warrantee and operations periods/phases. The web-based user's interfaces were set for each organizational tier and for quick and emergency responses using the GPS locations for the users, roadways and providers. On real time communication, simultaneous functionality of the integrated databases provides ultimate optimization while the unified filing system and document control solution facilitates system integrations of the management knowledge areas. Public outreach enhancement with a project specific website displays permitted information to allow public search and view projects general information including alerts and status.

### CROSS REFERENCE TO RELATED APPLICATION

This application is a continuation-in-part application of applicant's co-pending application Ser. No. 16/366,809 filed Mar. 27, 2019, which is a continuation-in-part of co-pending application Ser. No. 15/231,608 filed Aug. 8, 2016, that claims the benefit of Provisional Application Ser. No. 62/208,670 filed Aug. 22, 2015, the entire contents of which is hereby expressly incorporated by reference herein.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION

### Field of the Invention

The present literature and technology pertains to project management, traditional and technical. Software have been used in wide range of industries for several disciplines. Software examples are not limited to project planning, resource allocation, and scheduling. Some of the software allows and enables the managers and entire teams to control budget, quality, and all other exchanged documentation between parties and be notified using GPS locating through hardware when an emergency impacted their schedule in the project.

Description of Related Art including information disclosed under 37 CFR 1.97 and 1.98;

The world is changing, collaborating, and evolving, internet services provided the right media and became the common platform for communication, share knowledge, technologies and enhance developments. Management is the key factor that plays the major role in benefiting from these developments and take it to higher levels. Program and project management profession benefited from these improvements but still lacking a uniform and standard digital application for their industries.

In today's construction era, the projects delivery methodologies evolved too, typical delivery modules are not efficient to manage these large and mega projects, typical design-bid-build procurements does not answer the need for fast resolutions to development requirements. New, Design-Build, Public-Private-Partnerships, Construction Manager General Contractor, Design-Build-Operate and more modules has been introduced to the industry and proved to be efficient. Neither traditional management methodologies nor the new digitized software and platforms help in solving the problems of these innovative procurements. A need for an optimized, automated Computer program to integrate and standardize the management process and procedures are evolving; this disclosed invention provides the solution in a mobile, customizable, and flexible digital solutions.

In the construction industry, the exemplary complex example for the purpose of this invention solves these problems that become more complex and difficult to manage. The scattered and diversified published computer programs simplify and control some or specific areas of the industry but at the same time add up more complexity to the management processes. Due to the complexity and diversification of the Construction Industry and for the purpose of this patent registration the Design-Build delivery of the Construction Industry is used as an illustrative example. This shall address the ultimate program and the construction project management needs.

### BRIEF SUMMARY OF THE INVENTION

Disclosed invention is a cloud-based platform that is integrated, and complete computer program product provides solutions for management industries from initiation to completion, acceptance, and operation. This program was designed and built under new management approaches with major improved processes and differentiators as a replacement of the existing fragmented programs and applications.

The novelty of the differentiators reside in the integrated components of the Projects Management Office (PMO) and the Project Management Knowledge Areas (PMA) that provide managers with actual status of the project compared to the planned factors on a real-time basis. These integrated components of the program are not limited to the controlled level of collaboration of several organization and stakeholders involved in the projects but extends to progressively integrate project's scope tasks from initiation to completion, acceptance, and operation. Project management areas include Safety, Environmental, Contracts, Project Controls, Design, construction, Specialty disciplines management areas, and Quality.

The built-in automated integration with (third) 3^{rd} party tools and programs including enhances users' accuracy and provide full control on their tasks and related finished products. In addition, the novelty of this disclosed invention is the automated scans of the project and reference documents to create automated submittals log.

The project management office (PMO) is the organizational member's site in project initiation, planning, requests for qualification, proposal, bidding, and selection were established. Governing protocols, framework, identifying priority projects, receiving, and providing management reports. Setting up new projects and uploading contract documents and assigning project administrator for each project. PMO automatically receives project technical and financial status and incorporate within the overall company's executive reports. Such adds more efficiency and tighter monitoring and support to all projects.

In this disclosed invention and under the overall project management innovative approach as the project management knowledge areas (PMA) were identified by seven (7) main disciplines with an additional one (1) knowledge area for Quality Management. The quality management approach is a major differentiator and functions as the backbone of the projects. The PMAs (Project Management Knowledge Areas) subsets each one of them to another seven sub-tier structure which have been created as the unique standard in this management program/system and differentiate it from all other traditional management approaches. Such categorization enables this disclose invention to be applicable not only on construction project management (our exemplary example) but on several other industries too.

The other novelty of this invention is related to the PMAs categorization, industry standards classify them into ten (10) management areas, while in this invention the project management was built on an optimized approach utilizing the seven (7) tier formula to restructure the Project Management Knowledge Areas (PMAs). Optimized PMAs have been classified and categorized as: Safety Management, Environmental Management, Contracts Management, Project Controls Management, Design Management, Construction Management, Specialty disciplines Management, and the backbone of the seven management areas Quality Management. Each one of these management areas is sub-classified to other seven (7) sub-areas and so on.

The special features of this invention are not limited to integrating drawings, photos, and GPS, but extends to the project's forms with the databases to progressively manage plans, submittals, traffic, roadway closures, crises, and incident alerts. In addition, the following features differentiate this invention the built-in automated surveillance and formal audits, inspections, material, testing, non-conformances, changes, request for information (RFIs), Right-of-way management (ROW), temporary construction easements (TCEs), plans markup (as-built), punch-list, work completion reporting, and all other project items towards completion, acceptance, and the progressive closeout feature of the program.

Construction, Quality, and Risk management solutions are the major composites/parts of this program; due to the functionality and requirements similarities between Risk management ISO 31000 and Quality Management ISO 9001 especially when it comes to uncertainty, this program partly integrated the two process groups into one solution. Quality and risk management integration provide adequate tools to eliminate confusion and to better mitigate risk and provides clear, common understanding, and uniform knowledge on project's quality results.

In addition to Quality, and Risk management solutions, the disclosed program addresses other program/project management process like Integration, Communication, Scope, Time, and Cost management groups. Human Resources and Procurement management groups are managed at a sectorial section especially dedicated for each stakeholder/organization based on their specific rule and operation. This disclosed invention with its innovative approach meets the needs and comply with the Project Management Institute requirements for knowledge areas.

In this disclosed invention Seven (7) total User's Interfaces were provided to facilitate and to optimize integration, communication, collaboration, and conducting day-to-day tasks. User's Interface 1 (UI1) for the general Administrator, User's Interface 2 (UI2) for the Project Adminstrator, User's Interface 3 (U13) for the project management, User's Interface 4 (UI4) for remote and field users on handheld tablets, User's Interface 5 (UI5), the portable cellular phone interface is the Emergency/Crises response and the Quick access for other quality related topics. User's Interfaces UI6 and UI7 are subsets, additional (extended) interfaces of UI3 and UI4, specifically assigned for post construction during warrantee and operations phases respectively.

The automated form creation, Uniform Filing System are integrated, standardized, and customizable processes, procedures, and workflows including the interconnectivity of all project's activities to project's schedule unit identification numbers (ID's) that enhances and optimizes performance and provide the basis for the progressive management, closeout, and acceptance approach.

Disclosed invention and claims include more detailed specifics for enhanced and automated system, tools, and processes for all project teams and users to conduct their day-to-day tasks, assignments, and to track statuses and trends on a one-stop solution that provides a comprehensive and complete range of project management services on one single platform.

This disclosed on-stop solution platform enables users to communicate, collaborate, and to conduct their operations while in the office or remotely either in the field or away. Office desktops, laptops, portable handheld tablets, and or mobile cellular phones are all applicable devices to access and utilize this solution.

Various objects, features, aspects, and advantages of the present invention will become more apparent from the following detailed description of preferred embodiments of the invention, along with the accompanying drawings in which like numerals represent like components.

### BRIEF DESCRIPTION OF THE SEVERAL VIEWS OF THE DRAWING(S)

FIG. 01 illustrates Project Lifecycle Phases within the Project Management Office (PMO) and the Project Management Knowledge Areas (PMA) diagram.

FIG. 02 illustrates Cloud Servers, program, members, and projects databases including user specific interfaces block diagram.

FIG. 03 shows Project Management Office (PMO), Cloud servers and data bases, Project Components, Functions, and Relationship block diagram.

FIG. 04 shows and illustrates PMO Members, Projects Databases, and Functionalities.

FIG. 05 block diagram shows integrated relationship between Project Management Office (PMO) and Project Management Knowledge Areas (PMA).

FIG. 06 shows the implementation of notification of a member on their phone or tablet using the emergency mapping program.

FIG. 07 is a flow diagram that illustrates the usage of the embedded Uniform Filing System (UFS).

FIG. 08 is a schematic flow diagram that presents the form developing capabilities during project.

FIG. 09 is a follow diagram that represents the meeting management procedure.

FIG. 10 is a flow diagram that illustrates the automated submittals management and related review and approval process to generate adequate responses on timely manner.

FIG. 11 is a flow diagram that represents the maintenance of traffic in general and controls in a timely and automated manner the traffic control aspects of this management area.

FIG. 12 is a flow diagram illustrating the automated reporting procedure.

FIG. 13 is a flow diagram that illustrates the quality control and assurance.

FIG. 14 is a flow diagram presents general diagram that illustrates the change management process and procedure on a project.

FIG. 15 is a flow diagram illustrating the progress payments methodologies for any type of procurement.

FIG. 16 is a flow diagram that illustrates the non-conformance reporting, that is starting with capturing deficiency as an issue.

FIG. 17 is a flow diagram that illustrates the Request for Information (RFI) process and procedure.

FIG. 18 is a flow diagram that illustrates the automated Progressive closeout and its requirements.

FIG. 19 is a flow diagram that illustrates the automated auditing process of the project.

FIG. 20 is a flow diagram that represents the performance measurements based on the preset performance indicators for both the project and the individuals working on the project.

FIG. 21 is a flow diagram that represents task management, it illustrates how managers can assign tasks to users and from different approaches.

FIG. 22 is a flow diagram that represents schedule monitoring process and provides actual schedule progress and updates at any point in time during execution, construction.

FIG. 23 is a flow diagram that illustrates the Notice of Design Change (NDC).

FIG. 24 is a flow diagram that presents the automated bidding process and procedures.

FIG. 25 is a flow diagram that provides the materials tests compliance and verifications for quality acceptance.

FIG. 26 is a flow diagram represents generation of punch list items of the project.

FIG. 27 is a flow diagram that clarifies material testing process and procedure.

FIG. 28 is a flow diagram that illustrates the automated inspection and verification process.

### DETAILED DESCRIPTION OF THE INVENTION

It will be readily understood that the components of the present invention, as generally described and illustrated in the drawings herein, could be arranged and designed in a wide variety of different configurations. Thus, the following more detailed description of the embodiments of the system and method of the present invention, as represented in the drawings, is not intended to limit the scope of the invention but is merely representative of various embodiments of the invention. The illustrated embodiments of the invention will be best understood by reference to the drawings, wherein like parts are designated by like numerals throughout.

While this technology is susceptible of embodiment in many different forms, there is shown in the drawings and will herein be described in detail several specific embodiments with the understanding that the present disclosure is to be considered as an exemplification of the principles of the technology and is not intended to limit the technology to the embodiments illustrated. The terminology used herein is for the purpose of describing particular embodiments only and is not intended to be limiting of the technology. As used herein, the singular forms “a,” “an,” and “the” are intended to include the plural forms as well, unless the context clearly indicates otherwise.

It will be further understood that the terms “comprises,” “comprising,” “includes,” and/or “including,” when used in this specification, specify the presence of stated features, integers, steps, operations, elements, and/or components, but do not preclude the presence or addition of one or more other features, integers, steps, operations, elements, components, and/or groups thereof. It will be understood that like or analogous elements and/or components, referred to herein, may be identified throughout the drawings with like reference characters.

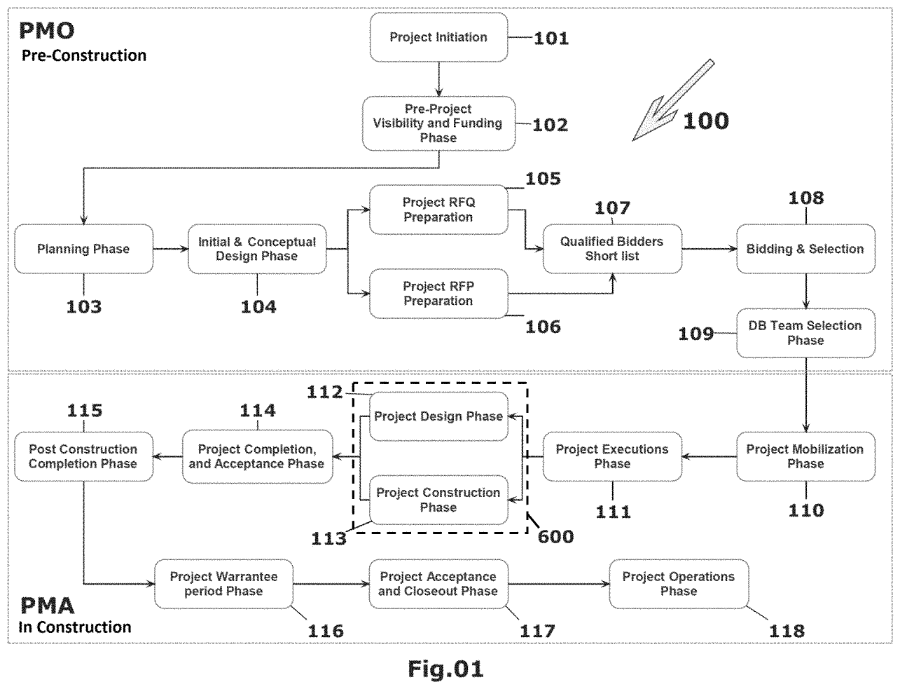

FIG. 01 illustrates Project Lifecycle Phases within the Project Management Office (PMO) and the Project Management Knowledge Areas (PMA) diagram for the Design-Build Project Lifecycle Phases, existing programs provide distinct solutions for each phase or part of the phase, and in most cases the tools of these solutions are disconnected and do not integrate data nor reflect real time information of the project in full or partly. In this presented invention, the solutions were designed and presented to maintain the same lifecycle phases with major enhancement by splitting the phases in two groups. Group one is under Project Management Office (PMO) and Group two is under Project Management Knowledge Areas (PMA). Some projects under group one may not progressed to group two, some others may continue until completion and operation. In this case, all data and information are automatically reserved and saved as a reference for future projects.

The user will start a project initiation 101 through several phases, such initiation, after securing funds 102, and is applicable for project owners planning 103, and completing the initial conceptual designs 104, and requesting prime contractor(s) pre-qualifications (RFQ) preparation 105 and completing the Request For Proposal contract documents (RFP) preparation 106, selected qualified bidders short list 107 will automatically receive the RFP ready to bidding & selection 108 and submit for contract winner DB team selection phase 109 and contract award. This upper portion of the figure represents pre-construction steps.

This same logic and process is applicable for designers, prime contractor, and quality management for key sub-consultants and sub-contractors including material testing laboratories and field inspection services. All information, data, and references are automatically saved, synchronized electronically, and integrated through submittals and owner's approval process.

The lower portion of the figure provides the in-construction steps. In an instance a contract is awarded, the project mobilization phase 110 requirements that are automatically submitted for approval and the process is electronically followed through project execution phase 111 in which project design phase 112 will be completed, RFC released for construction plans are issued and the project construction phase 113 is started.

The project design phase 112 and the project construction phase 113 both utilize an emergency mapping program 600 that links the project construction steps with GPS locators for the construction location and the GPS cell phone (and other) hardware locators in the users.

The project completion and acceptance phase 114 reflects the final project completion and acceptance phase and to be followed by the post construction completion phase 115, which is the project warrantee period phase 116 and the project acceptance and closeout phase 117, in preparation to the project operational phase 118.

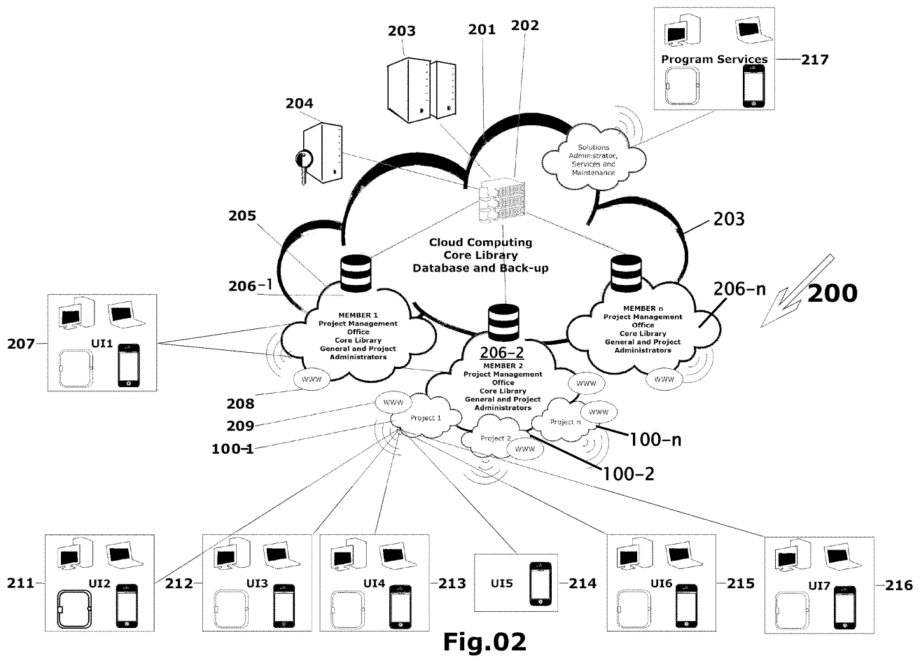

FIG. 02 which illustrates Cloud Servers, program, members, and projects databases including user specific interfaces block diagram provides the relation for the integration and the real time data processes. This process reflects the projects 100-1, 100-2 to 100-n from initiation to completion including the separate databases 202, 203 and 204 for each member 206-1, 206-2 to 206-n and each project 100-1, 100-2 to 100-n through separate user interfaces 207, 211, 212, 213, 214, 215, 216 and 217. Each of these user interfaces represent hardware, including but not limited to cell phones, laptops, desktop computers and tablets that have GPS locating capability to identify where they are physically located. Within the project the GPS location of the hardware cell phones, laptops, desktop computers and tablets at any point in-time and where the hardware is predicted to be at a future time. 201 represents the presented invention's cloud that hosts the programs master program database 202 server which is connected to the program's backup and update server and are connected through a cloud 300 and through user separate websites 208, 209 etc and their cloud 205 connection(s).

Such cloud servers, database processors, and the separation between members (organizations) provide the bases for PMO and PMA relations privacy and integrated functionalities. Within the Project Management Office (PMO) and the Project Management Knowledge Areas (PMA) diagram

Creating and integrating the Projects Management Office (PMO) with the Projects through Project Management Knowledge Areas (PMA) including all specific discipline activities with multiple stakeholders are the major systems differentiators of this invention. Such facilitates the transfer of information from initiation to execution and at the same time interconnects projects with the organizational executive data and information and allows both PMO and PMA to provide manage the overall picture of the projects and to resolve obstacles, issues, emergencies using the emergency mapping program (not shown in this figure) and/or impacts on timely manner.

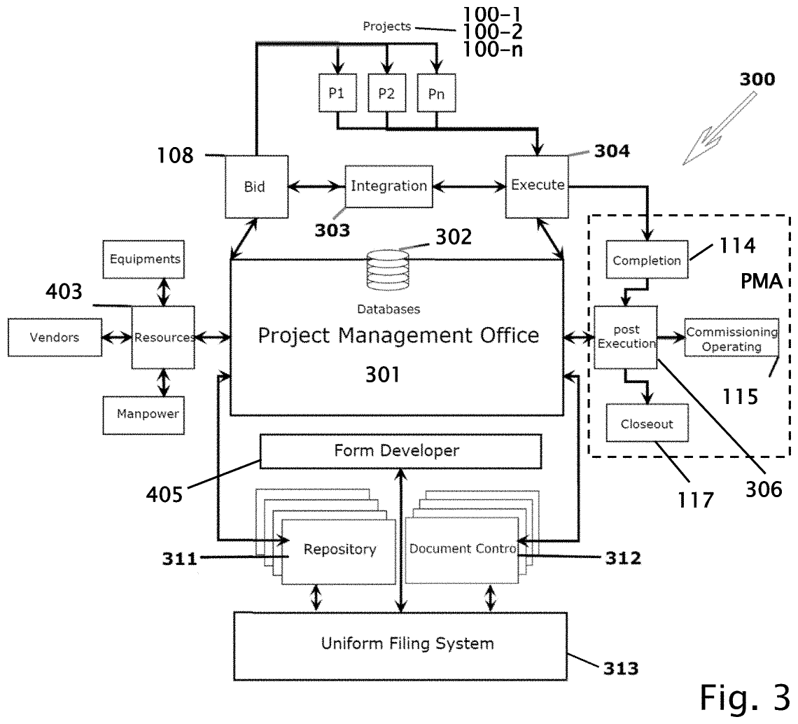

FIG. 03 shows Project Management Office (PMO), Cloud servers and data bases, Project Components, Functions, and Relationship block diagram of the project management office 300 and illustrates the sub-cloud that represents the program/Project Management Office (PMO) 300, with its components that is not limited to processors, primary memory, databases, communication infrastructure, communication interfaces and displays and the contract modules, member's rules. All with the central documents and records repository for a member to utilize. These interactive components are resided on a cloud and shown as the central repository 302 database for the projects 100-1, 100-2 to 100-n. There are several resourced 403 that are available and can be used including, but not limited to equipment, vendors and manpower.

When a project is bid 108 the bid, the bid 108 is communicated to the project management office 301 integration 303. At integration 303 the bid/job/project 101-? is authorized for execution 304. When the project 100-? is being executed 304 the project (or portion of the project) is managed by the project management office 301 until the execution 304 progresses to completion 114. After completion 114 there is a post execution stage 306 where there is a commissioning operation 115 and a project 100-? closeout 117. The post execution 306 construction support of the project management office 301 goes beyond the closeout 117 and carries over to the commissioning operation 115.

When a project is being created, the project management office 301 can use or modify a form developer 405 using documents in the repository 311 and maintain the document using a document control 312 system with a uniform filing system 313. The post construction support of the project management office 301 goes beyond the closeout 117 and carries over to the commissioning/operating. The resources database of the program/project management office 301 enriches the bidding 108 support as well as the project performance during execution 304. All of these services are available and ready to be provided to the projects in all phases and all based on the program/project management repository 311 and its document control 312 in the uniform filing system of the program in the form developer 405.

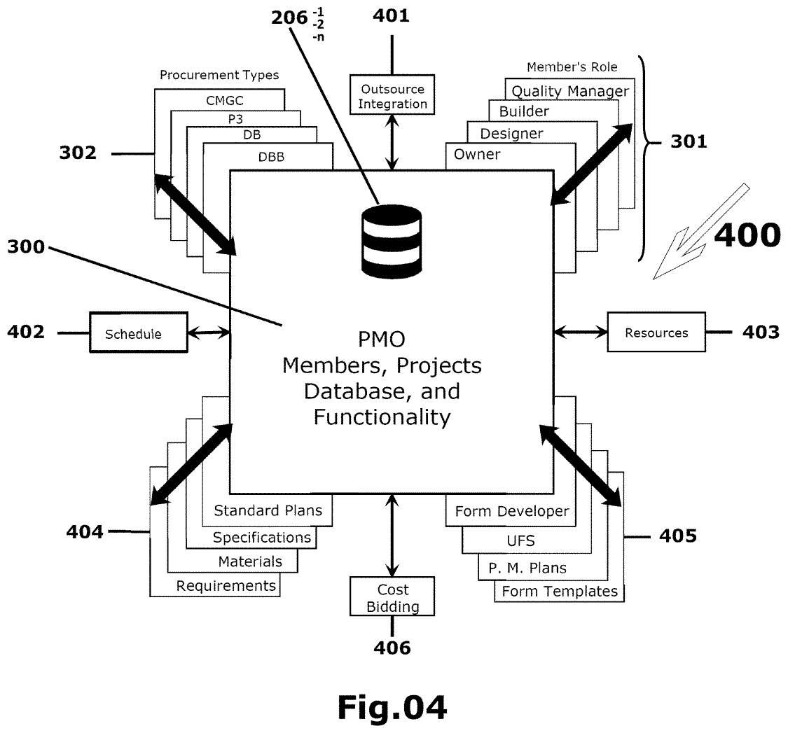

FIG. 04 shows and illustrates PMO Members, Projects Databases, and Functionalities in the program and the pre-designed packages for project procurement types, member's rule on the project, and contains the backup data for the project standards, specifications, templates, plans and other requirements 400. This database system functions and support's member's business functionalities during the day-to-day operations, bidding on projects, while executing, and post completion. The Member's Project Management Office (PMO) Database 300 of the program and the pre-designed packages for project procurement types 302 that include the construction manager general contractor (CMGC), public-private partnership (P3), design-build (DB) and design-bid-build (DBB). The member's rule 301 includes the member's rule on the project as 206-1, 206-2 to 206-n. There are also groups 404 and 405 of project standards, specifications, templates, plans and other requirements for developer program that is embedded in this program. The database contains all schedule 402, resources 403, outsourcing integration 401 and cost bidding 406 data and information. This database system functions and support's member's business operations during the day-to-day operations, bidding on new projects, while executing other projects, completing, or closing other more, and conducting post completion operations on some other projects too. It is the central heart of the program.

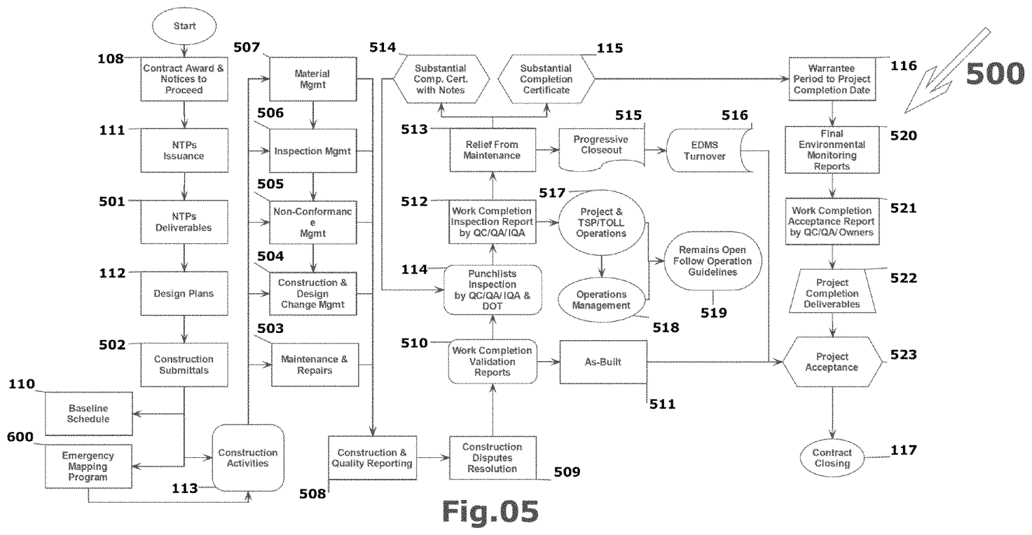

FIG. 05 illustrates DB Project Start, Completion, and Acceptance Process Chart 500. At the start of a project a contract is awarded and given notice(s) to proceed 108 with the contract. The notice to proceed (NTP) is issued 111. The notice to proceed (NTP) includes deliverables 501. The design plans 112 are created or distributed for the contraction submittals 502. The project plan is entered into a baseline schedule 110 with an emergency mapping program 600 that includes global positioning sensor (GPS) and geographic locators for the contractors, members and location for all aspects of the project. The GPS and geographic locators use real-time data for locating and communicating project progress and emergency changes to the project, contractors and participants through the mapping program without a user making changes to the project for the construction activities 113.

After the project entry into the database(s) there are maintenance and repairs 503, construction & design change management 504 non-conformance management 505, inspection management 506 and material management 507. These functions communicate to the construction & quality reporting 508 that goes to construction disputes and resolution 509 that goes to the work completion validation reports 510. From the work completion validation reports 510 the project can go to as-built 511 or to a punch list inspection by QC/QA/or IQA & DOT 114. From the punch list inspection by QC/QA/or IQA & DOT 114 the project goes to a work completion inspection report by QC/QA/IQA 512. From the work completion inspection report by QC/QA/IQA 512 the project can go to a project & TSP/TOLL operations 517 or to a relief from maintenance 513.

From the relief from maintenance 513 the project can go to an operations management 518 and/or ultimately end where the project remains open following operation guidelines 519. From the relief from maintenance 513 the project can progress to a substantial compliance certificate with notes 514 and then back to the punch list inspection by QC/QA/or IQA & DOT 114, or to a substantial completion certificate 115, or to a progressive closeout 515.

From the progressive closeout 515 the project will continue to Electronic Document Management System (EDMS) turnover 516 then to project acceptance 523. If the project goes to the substantial completion certificate 115 the project will continue to the warrantee period to project completion date 116 to a final environmental monitoring reports 520, then to a work completion acceptance report by QC/QA/owners 521. The project will then continue to project completion deliverables 522, then to project acceptance 523 and the ultimately contract closing 117.

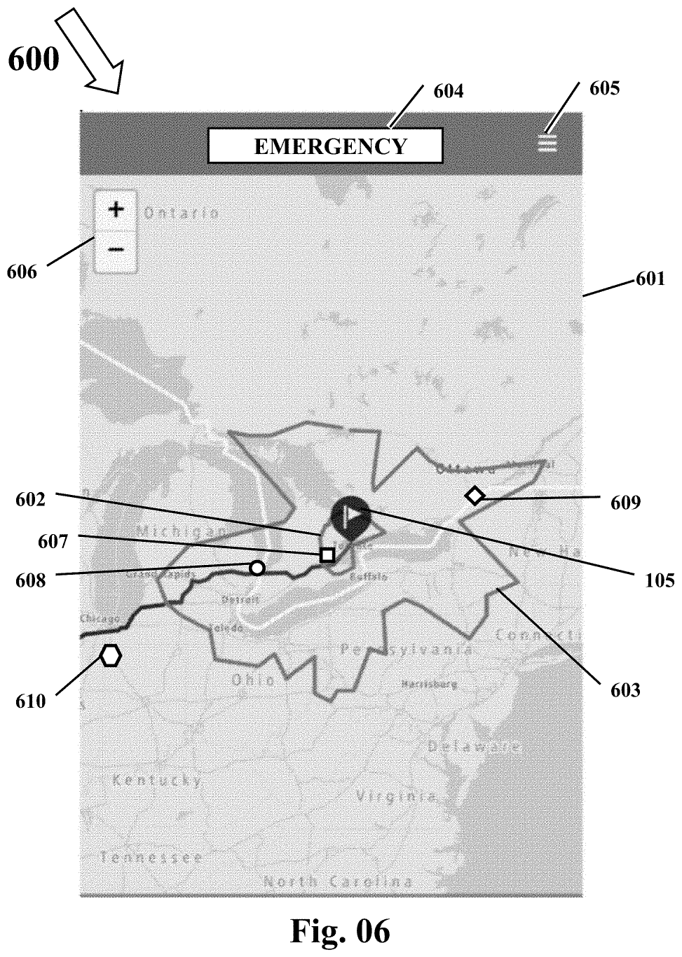

FIG. 06 shows the implementation of notification of a member 105 on their phone, tablet, computer, or smart watch using the emergency mapping program 600. When an emergency 604 or in proximity to the project the emergency mapping program 600. The emergency mapping program 600 is not restricted to emergencies that exist from the project, but also from any unscheduled event or disruption that can affect the project schedule. Examples include, but are not limited to, a fire or traffic event that can require notification or earlier departure of people or equipment to accommodate a delay.

In the example of a brush fire in proximity to a delivery of time sensitive material such as cement, while the brush fire may exist miles from a construction site, it can cause a traffic delay that will affect when a delivery of cement will arrive. The emergency mapping program 600 uses the physical location of the phone, tablet or other GPS enabled device with the real-time and future projected delay for notification of devices and people that are, can and maybe effected within the mapped outline area 603.

In this example, a real-time alert notification to member 105 that would pop-up and require immediate action. From this notification, the member 105 is presented with an outline 602 of an area of immediately effected geographic area. Additional members 607-610 maybe shown inside or outside of the outline 603 and the member 105 can send notifications to others within the outline 603 for public outreach. The icon type or shape of the additional members 607-610 can represent the type for function of the member(s).

The member 105 can use their fingers to reduce, expand or alter the outline 603 to include or exclude other members 607-610. The outline 603 can be manually expanded by touch drawing, or the emergency mapping program 600 can self-expand (or contract) based upon known topography and/or traffic corridors. The member 105 can further increase or decrease 606 the zoom area of the map. Other actions 605 from a pull-down menu allows the member to include or exclude other member types and change how other members are notified by text message, automated phone call, email, or schedule update. While this emergency mapping program 600 is shown and described for an emergency, it can be equally utilized for closures, accidents, power interruption, traffic or other anticipated or not anticipated delays. It is further noted that while this is intended for real time delay communication, it could also be used for expedited events of people or material arriving ahead of schedule.

While in the field, any of the project users can respond to crises, emergencies, incidents, this provide systematic process to utilize and implement, starting from calling emergency, text messaging or sending an alert (like an amber alert) to responders ending with documenting and reporting the incident. The alert can be a pop-up for immediate notification of a user based upon the level of involvement in the schedule or a change that effects the schedule by knowing the present or future GPS location of each person and process. Multiple pop-ups and alerts may occur to ensure that the user sees and acknowledges each change/alert. Communicating with project safety team and managers through solutions phone calls, messaging and/or emails features are part of this solution, in which and under tremendous stressful situation a user can perform such crises management through a pre-standardized process to call projects and formal emergency and safety responders to the scene in timely manner. Similar feature was specifically designed for near misses' documentation and reporting.

The emergency mapping program 600 with the interface dashboard allows a user to view the status of the project changes to the project and events that can have an immediate effect on the schedule, budget, and traffic flow. Different levels of notification can be set for each user based upon the level of involvement with the project. The dashboard can automatically send an email, text message or place and automated phone call when urgent attention is needed.

As some examples, a delivery of rebar that will be used in a portion of the project that will be needed in the future days or weeks may have little or no notifications because changes of several days to a schedule has limited effect. A delivery of cement may require an immediate text message, call, or email if an accident occurs at the job site or in the travel direction of the cement truck because the cement has a limited shelf life. Traffic and Law enforcement may also require an immediate text message, call, or email in the event of an emergency rather than waiting for the user to pro-actively check the dashboard for any update. These notifications can be sent like an Amber alert to effect members so a rapid response can be made. The alert can be a pop-up for immediate notification of a user based upon the level of involvement in the schedule or a change that effects the schedule. Multiple pop-ups and alerts may occur to ensure that the user sees and acknowledges each change/alert. The affected member may adjust through their project interface that may result in the project sending notifications to additional members or cancel notifications to members that will no longer be affected. In the public outreach program, a commuter could set alters for construction delays, so they receive pro-active notifications before they begin a daily commute without a need to visit a community outreach site or the dashboard system or find the delay when the user is traveling through and area that is affected.

While all users can access their portion of the dashboard or project to view, update the project, the alert is sent when needed to members that may be sleeping to alert them to a situation where emergency action is needed.

There is further a photo management features allow for capturing project's photo documents and incorporate these photos at the report where they belong too, user can mark, and write on the photos, while the system automatically assign, name, date, time, location and 3-dimensional GIS coordinates for each photo; pre-defined photo naming convention will be automatically inserted and tag each photo. All projects photos are also saved at a project's master photo file to track project and construction progress time line. These photos can be taken, labeled, saved, and documented as either Pre-Construction, During construction, or post construction.

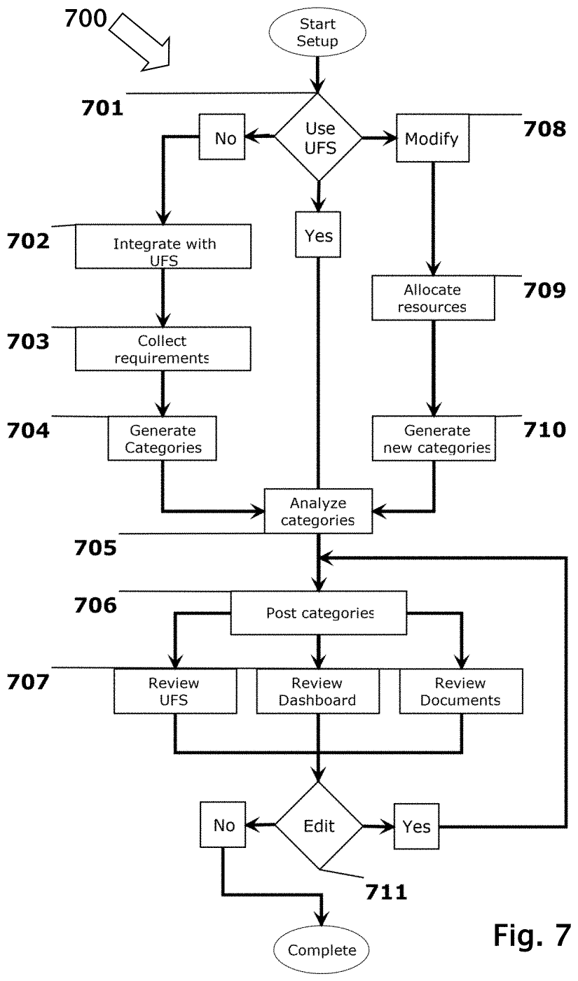

FIG. 07 is a flow diagram 700 illustrates the usage of the embedded Uniform Filing System (UFS) while in the initial project setup phase as shown in 704, or more in details about project setup continuation after award which includes subs and setup updates. The embodiments of the uniform filing system are flexible and subject for modification as per the project needs. Member's general administrator and/or the project administrator may share the efforts of project setup pre-award for the general administrator and post award for the general administrator. The general administrator may carry this rule along from initial setup to updating if elected not to delegate this task to the project administrator. Sections from 701 to 711 reflects these functions and features as stated in FIG. 07.

The digitized and fully automated Uniform Filing System (UFS) is capable of categorizing and presenting folders and files in several formats, either under the standardized project management areas or as per other filing categories as users deem necessary to comply with for their own use. The project's uniform filing system provides efficient document control and in general project management solution in which all project documents are located and easily accessible through several locations of the program including the direct access through the dashboards of the program.

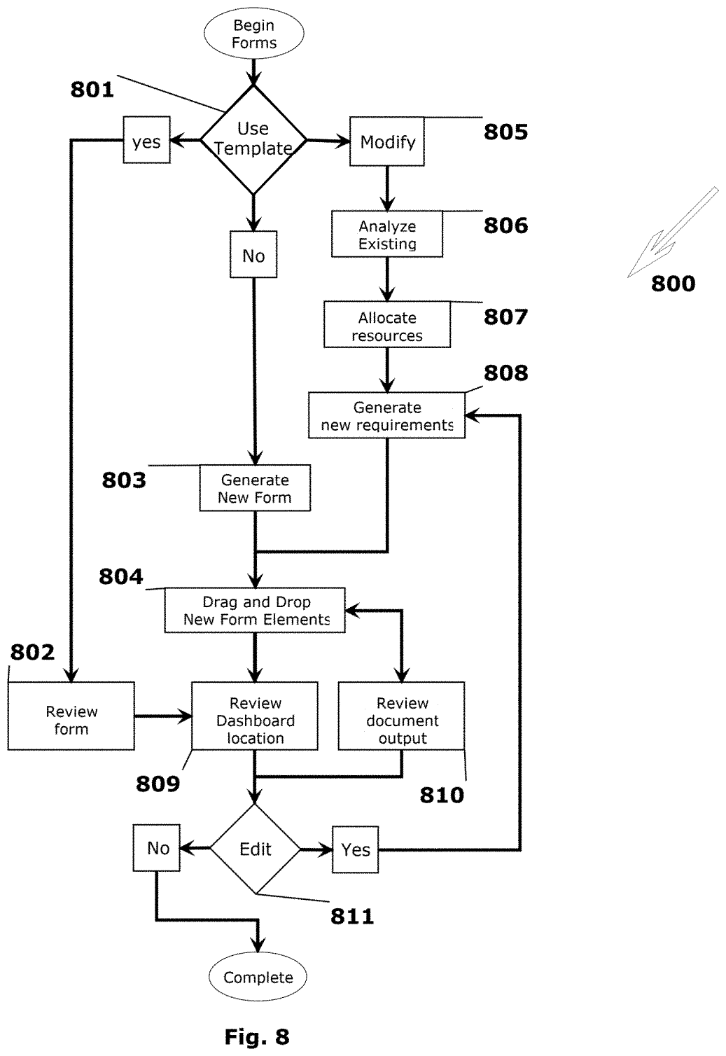

FIG. 08 is a schematic flow diagram 800 presents the form developing capabilities during project setup and in addition allows the project administrator to edit, modify, delete, or add new components to any of the project forms utilizing a drag and drop form developing software already embedded in the system. New, modified, or edited forms are automatically stored where they belong to in the unified filing system also embedded in the program, i.e., no need to utilize any of the conventional methods like “save as” or to “save it at” or similar. The provided option of using existing templates and presents the form developing capabilities during project setup and in addition allows the project administrator to edit, modify, delete, or add new components to any of the project forms utilizing a drag and drop form developing software already embedded in the system.

Standard management form templates are added to this interface with an option for the users to modify, adjust, edit, or to create new or specific forms based on their needs. Such editing or creation does not influence or affect the standardized project management process and procedure of this disclosed invention. Such facilities can be migrated or uploaded to the new programs or projects while utilizing the adding new, setup or projects features. This program provided several access points for each feature to minimize search and to allow users for faster and more productive work environment. Through same interface, users can edit users' profiles and update member's and user's information, upgrade the program, and call for customer's support, all are under one interface.

Disclosed invention, the project management system was designed and built with pre-set standard fillable forms, capable of automatically uploading users' specific forms, in addition to a special built-in form creation—development—software in which all data are automatically integrated with the program and system database with an automated metadata input, output, and functionality.

This facilitates automated features to fill up name, day, date, time, and weather tracking status in each generated report without any interference from the report creator. Report creator can edit and adjust some of this information based on the situation the report is generated for. At the same time, remote and field users can access the weather forecast to document and alert project team of any upcoming weather situations. All project reports, material, inspection, sampling and or testing automatically carry project document serial number and report creator can assign an extra report number specific for the type of assignment and the creator. In addition, field, remote users can access their specific interface from office desktops to edit, complete and sign their pre-generated reports prior to submittal for review and approval.

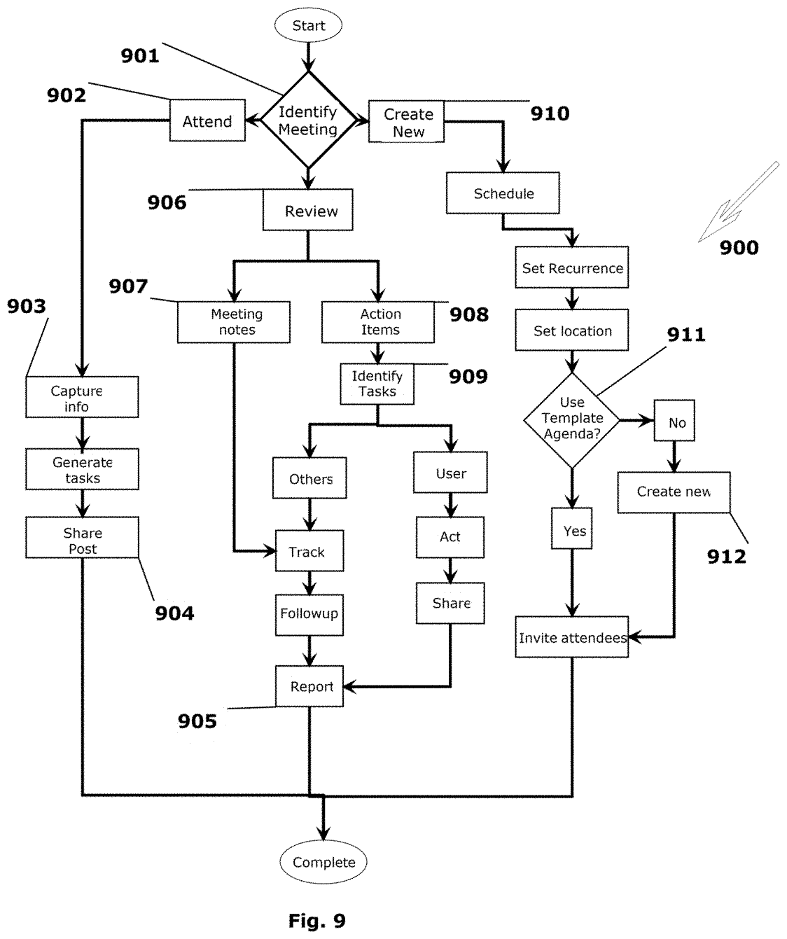

FIG. 09 is a follow diagram 900 representing the meeting management procedure already embedded in this program, it allows the project management to pre-set recurring meeting and to tie attendees to positions and job titles while individual names will be reflected in the documents. In an aspect that an individual has been replaced with another person, the new name—the successor—will show up in the meeting documents. This feature automatically walks user through meeting process to setup a meeting, and/or to act and respond on the actions items resulting from these meetings. At the same time, meeting attendees will have all previous meetings information handy and accessible. Such feature enhances and improves meeting performance and efficiency. The meeting management procedure already embedded in this program as shown in 901 through 912, it allows the project management to pre-set and schedule recurring meetings and to tie attendees to positions and job titles while individual names will be reflected in the documents.

In this disclosed invention the Meetings Management module and features already embedded in this program and it allows the project management to pre-set recurring meeting and to tie attendees to positions and job titles while individual names will be reflected in the documents. This feature automatically walks user through meeting process to setting up a meeting to act and respond on the actions items resulting from these meetings. At the same time, meeting attendees will have all previous meetings information handy and accessible. Such feature enhances and improves meeting performance and efficiency. In addition, the system provides features for all types of meetings, re-occurring, task force, problem solving, issues resolution, and more.

In an aspect, an individual has been replaced with another person, the new name—the successor—will show up in the meeting documents replacing the predecessor's name. This feature automatically walks user through meeting process that includes setting up meetings, act and respond on the actions items resulting from these meetings as shown in 903, 904, 908 and 909 to 905. At the same time, meeting attendees will have all previous meetings information handy and accessible. Such feature enhances and improves meeting performance and efficiency. All meeting notes can be tracked as shown in 907 and 905. The system allows users to use existing meeting agendas templates or to modify or create new.

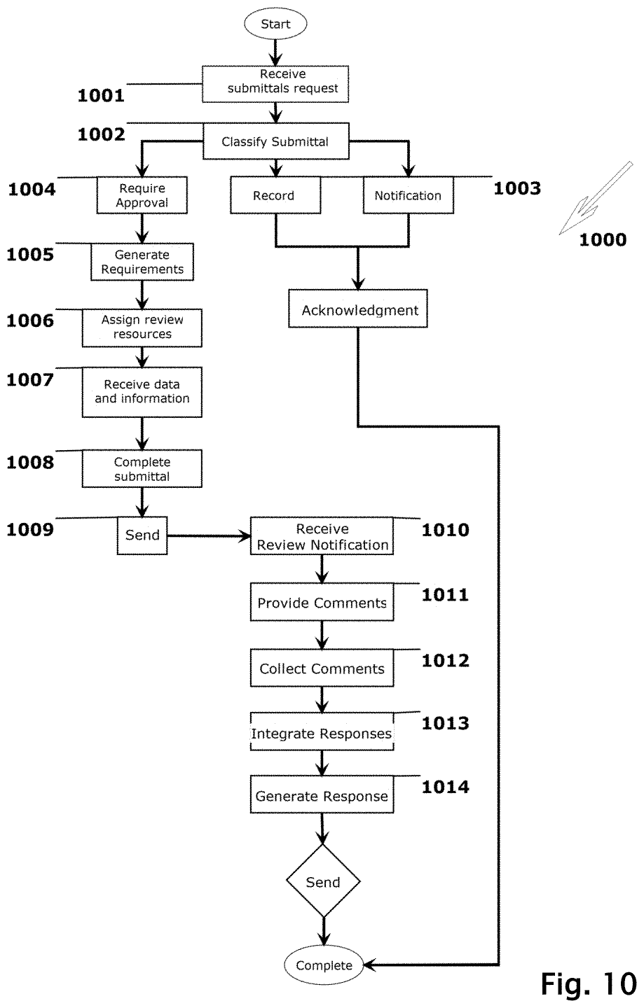

FIG. 10 is a flow diagram 1000 illustrates the automated submittals management and related review and approval process to generate adequate responses on timely manner. All submittals are tied to a metering system that controls time from initiation to response; such feature enhances better project planning and prevents potential time delay claims in the project. At the same time, all engaged personnel will be aware of the submittals progress on timely manner and may enhance over-the-shoulder meetings and discussions while documenting all in the same platform. The automated submittals management and related review and approval process to generate adequate responses on timely manner. The processes stated in 1001, 1002, 1003, 1004, 1005, 1006, 1007, 1008, 1009, 1010, 1011, 1012, 1013 and 1014.

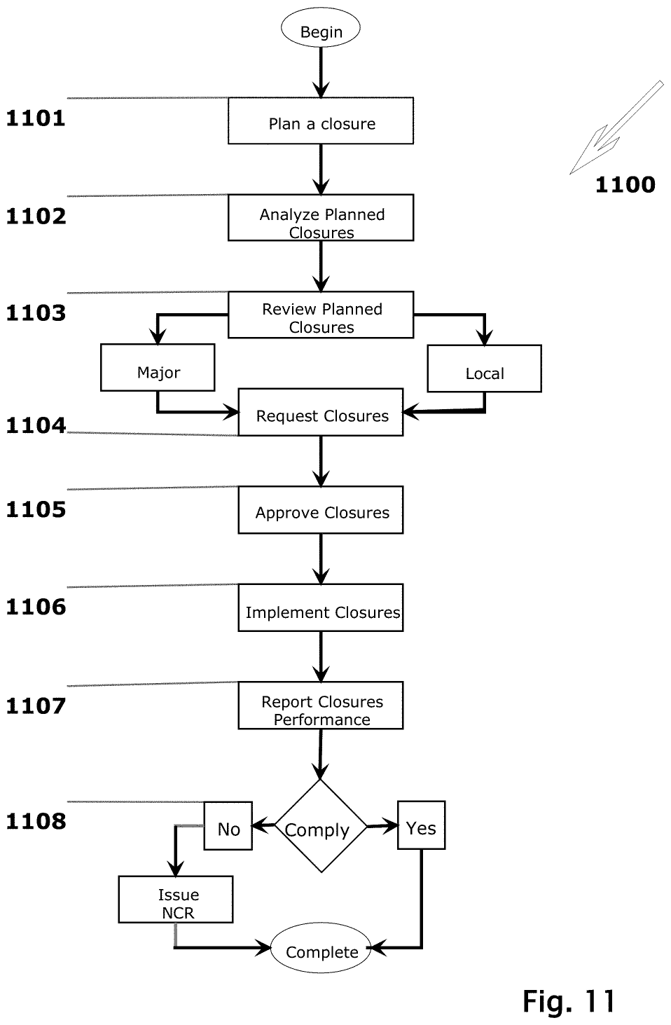

FIG. 11 is a flow diagram 1100 represents the maintenance of traffic in general and controls in a timely and automated manner the traffic control aspects of this management area. Based on the pre-planned work and the need to close a section of the construction site or a roadway the closure can be planned, reviewed, and analyzed, classified, and requested formally for approval. The GPS location for the roadways, traffic and maintenance is entered into the project to work with the emergency mapping program as previously described, With the traffic such approvals are automatically communicated with field's team to implement the closure as per the approved closures. In case a deficiency or non-conforming a non-conformance report is generated, and a deductive change order may be initiated. The maintenance of traffic in general and at the same time controls—in timely and automated manner—the traffic control aspects of this management area. Based on the pre-planned work and the need to close a section of the construction site or a roadway the closure can be planned, reviewed, and analyzed, classified, and requested formally for approval. Such approvals are automatically communicated with field's team to implement the closure as per approved. In case a deficiency or non-conforming a non-conformance report is generated, and a deductive change order may be initiated as shown in 1101, 1102, 1103, 1104, 1105, 1106, 1107 and 1108.

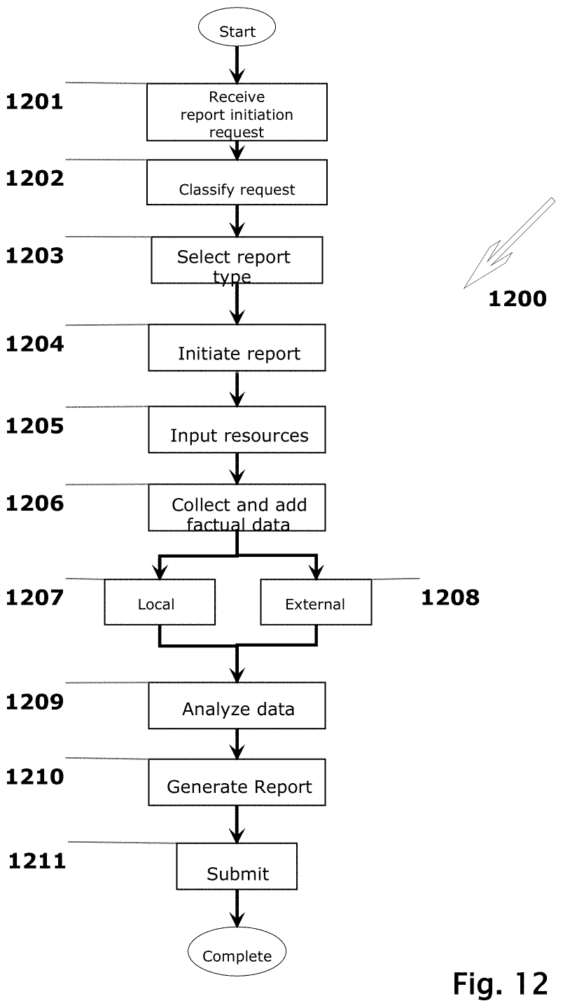

FIG. 12 is a flow diagram 1200 illustrating the automated reporting procedure, such is not limited to field inspection, but exceeds that to any type of inspection or reporting the project is requiring and was assigned during the setting up of the project itself. Such feature differentiates the type and level of reporting based on the rule of the user; as an example, contractor's reporting is a quality control type, and it differs from the quality assurance and the independent quality assurance reporting needs. This feature also allows for an oversight and third-party individual to conduct such verification based on their rule and project requirements. Also, in this figure the process is shown in 1201, 1202, 1203, 1204, 1205, 1206, 1207, 1208, 1209, 1210 and 1211.

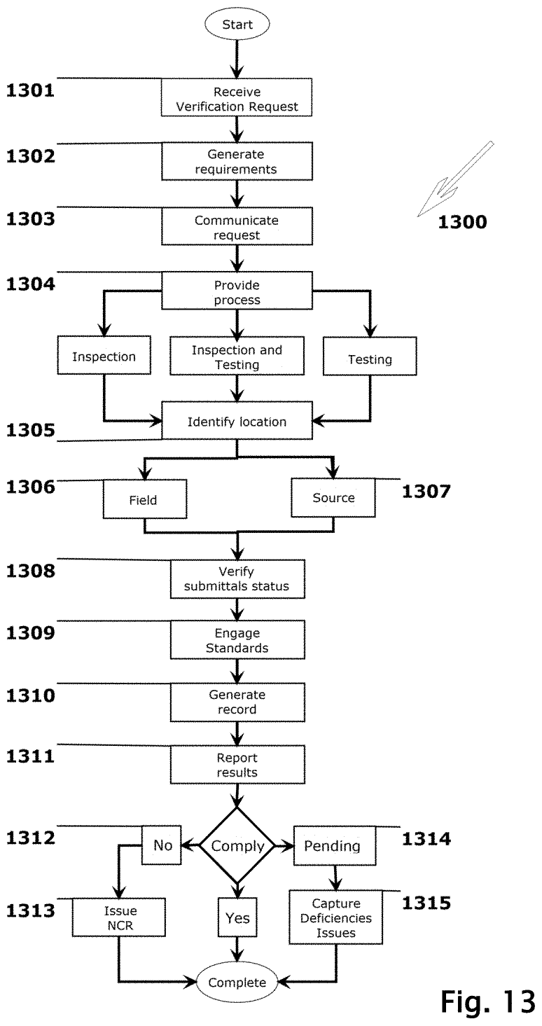

FIG. 13 is a flow diagram 1300 illustrates the quality control and assurance, it is the verification process that is not limited to material inspection and testing in the field or at source, it also facilitates an automated procedure for the inspectors to be aware of the standards and the materials requirements such as approved submittals that is not limited to shop drawings, mix designs or any other necessary document. This feature allows for a real time reporting process and keeps project personnel and management aware of the situation and results on timely manner. Such verification, inspection, reporting, and releasing as shown in FIG. 13 with items 1301, 1302, 1303, 1304, 1305, 1306, 1307, 1308, 1309, 1310, 1311, 1312, 1313, 1314 and 1315.

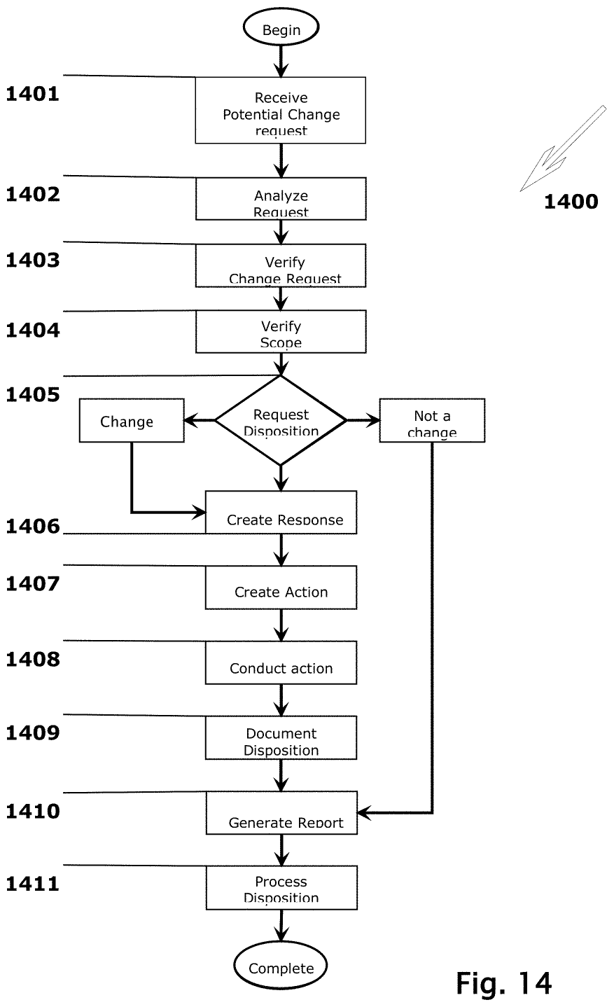

FIG. 14 is a flow diagram 1400 presents general diagram that illustrates the change management process and procedure on a project. Such begins with the potential change request and could be of any type or cause. This automated feature provides spontaneous access to project data and records to better assess the situation and verify if this request is within the scope of the project or not to facilitate thorough and accurate disposition to be taken and performed accordingly. The change management process and procedure on a project. Such begins with the potential change request and could be of any type or cause. The steps of this feature are described in blocks 1401 to 1411.

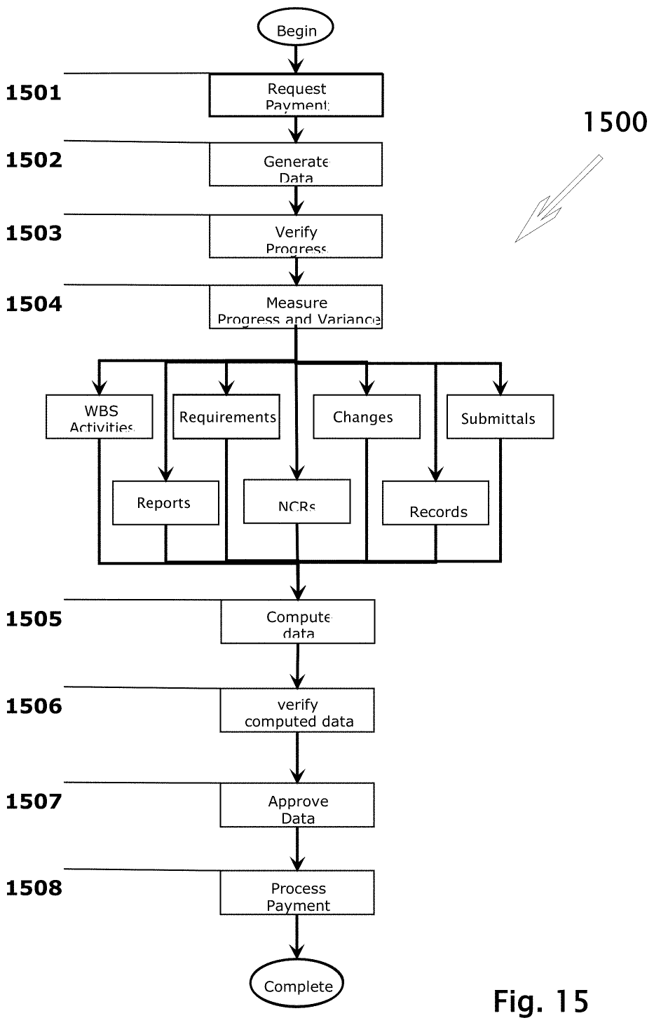

FIG. 15 is a flow diagram 1500 illustrates the progress payments methodologies for any type of procurement, this feature automatically ties the progress payment request to the contract requirements, the changes, the open or non-conforming items of the project. Project's process payment and control features are applicable while in the execution phase; such process and such feature ease the progress payments process and provides accurate payment estimates on timely manner to prevent any disputes or claims. The progress payments methodologies for any type of procurement as shown in blocks 1501, 1502, 1503, 1504, 1505, 1506, 1507 and 1508.

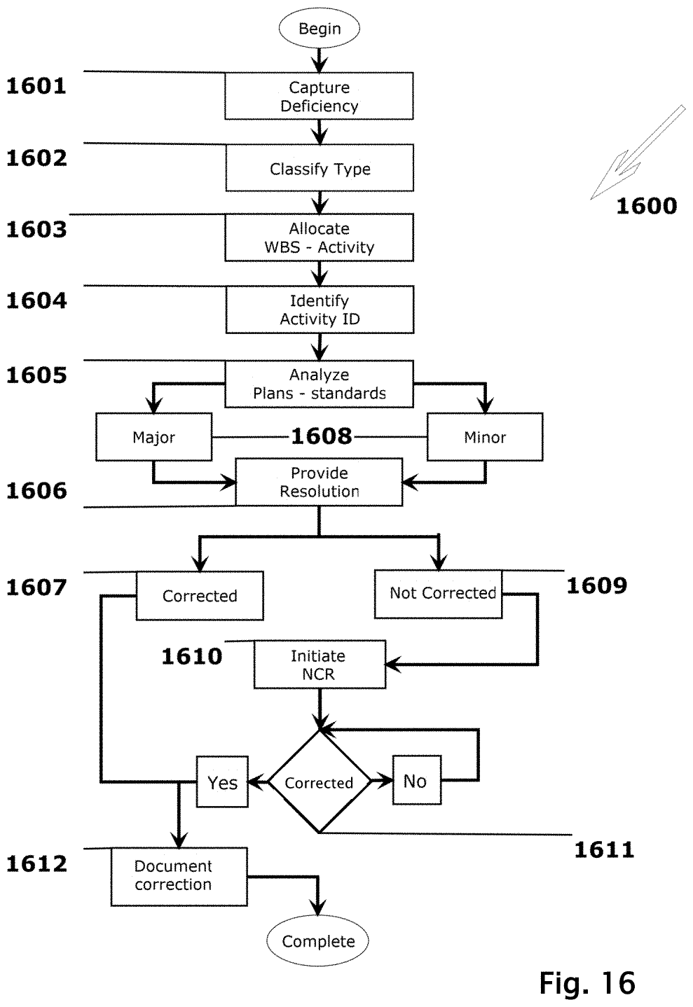

FIG. 16 is a flow diagram 1600 illustrates the non-conformance reporting, that is starting with capturing deficiency as an issue, tie it to the scope and the detailed activity and the related standard and then if not corrected while in progress a Non-Conformance Report (NCR) shall be issued to track corrective actions. The non-conformance reporting, that is starting with capturing an issue, tie it to the scope and the detailed activity and the related standard and then if not corrected while in progress a non-conformance report shall be issued to track corrective actions. Such non-conformance applies on project requirements, the technical and specifications of the project. The Non-Conformance is classified into two categories, Non-Conformance Report (NCR) and Non-Conformance Notice (NCN) both will be treated, corrected, and disposed/closed with the same automated digital procedure. Assigned responders will be notified immediately to take action and respond on a timely manner and an automated amber (type) alert will be generated and sent automatically to act and respond by the pre-set due date. The notification may require an acknowledgement from the receiver to ensure and track that the alert was read with a time and date stamp of the acknowledgement. The administrator can view what recipients have acknowledged the alert and what recipients have not acknowledged the alert. As shown in 1601, 1602, 1603, 1604, 1605, 1606, 1607, 1608, 1609, 1610, 1611 and 1612.

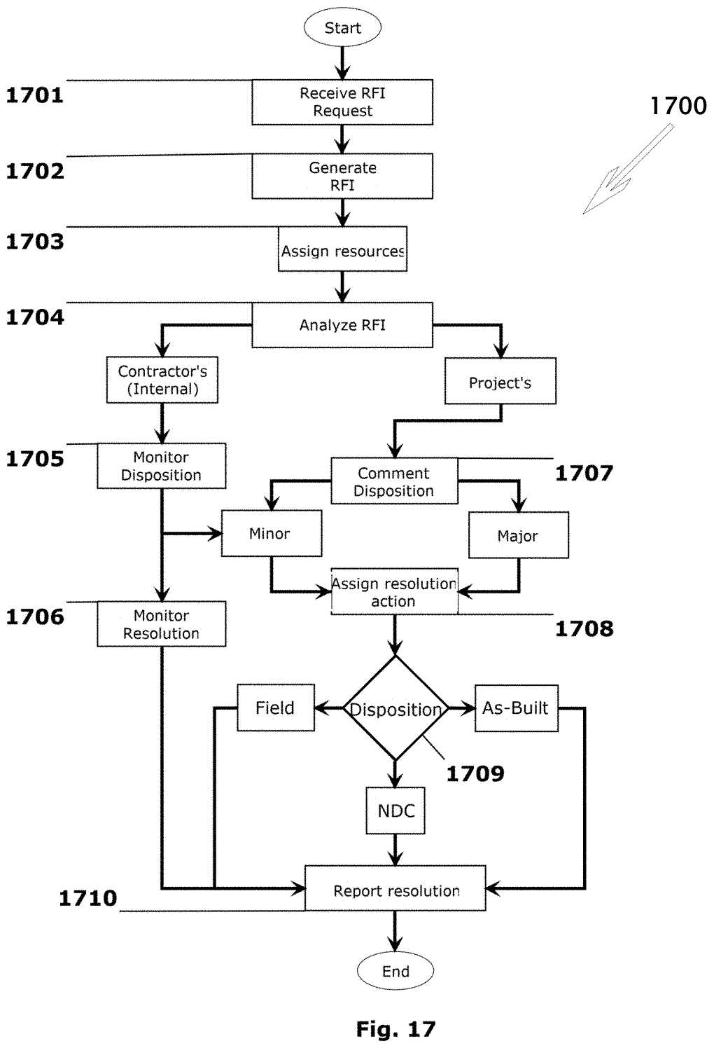

FIG. 17 is a flow diagram 1700 illustrates the Request for Information (RFI) process and procedure, this classifies the RFIs into contractor's and project's as shown in 1701, at the same time this reflects the minor and major at the same time. This allows all responsible personnel to monitor, comment and act on the submitted RFI and disclose in a timely manner, even if it ends with any type of disposition, field correction, design change, or to document in the as-built drawings. Work progress on the affected work elements will be stopped/ceased, project teams will be notified immediately, and responsible responder(s) will be automatically alerted to act and respond on timely fashion towards acceptable RFI disposition. Such automated notification and alert enhance performance and minimizes potential technical, financial impacts and delays on the project schedule. The notification may require an acknowledgement from the receiver to ensure and track that the alert was read with a time and date stamp of the acknowledgement. The administrator can view what recipients have acknowledged the alert and what recipients have not acknowledged the alert. All as stated in blocks 1701, 1702, 1703, 1704, 1705, 1706, 1707, 1708, 1709 and 1710.

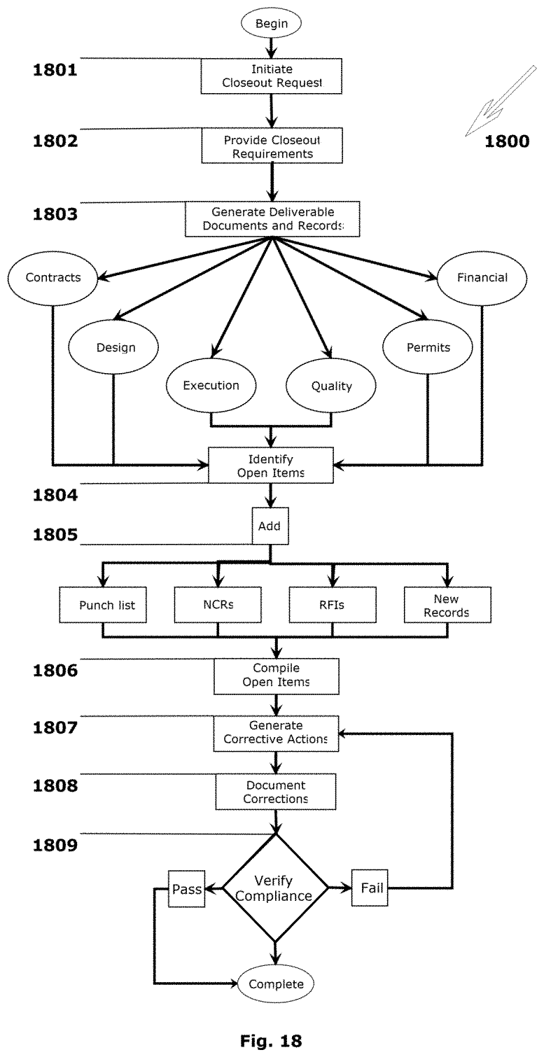

FIG. 18 is a flow diagram 1800 illustrates the automated Progressive closeout and its requirements, such process carries a specific closeout requirement based on the project setup. In the construction industry for example this feature automated the punch list and all other open items and allows the user to create final action items to complete all project documents and records to comply with the needs and to allow for seamless closeout. Project documents and records related to administrative, design, construction, and quality are captured progressively, and status is digitally shared with all project teams in timely manner. At the completion and disposition of any one of these documents and records the system automatically file it in the uniform filing system as per the agreed upon filing structure and categories. Otherwise, the document will remain open until completion. Progressive closeout out documents and records are not limited to design drawings, Inspection, and hold-point (CAPs) inspection reports, materials engineering and testing reports, non-conformance reports, request for information reports, field inspection and testing reports, survey data, structural records, submittals and transmittals, traffic, safety, environmental and SWPPP reports, work completion reports, and as-built drawings but may expand as per contracts closeout requirements. Such Progressive closeout feature allows project management to monitor project records and documents at any time of the project's lifecycle, such will motivate pro-active attitude to comply on as the project progresses. The automated notification and alert features will remain active and will prevent the project in part, or as a whole, to be accepted unless all open related documents and records are completed, accepted, and disposed. The automated Progressive closeout and its requirements, as stated above and in FIG. 18 and as shown in 1801, 1802, 1803, 1804, 1805, 1806 and 1809.

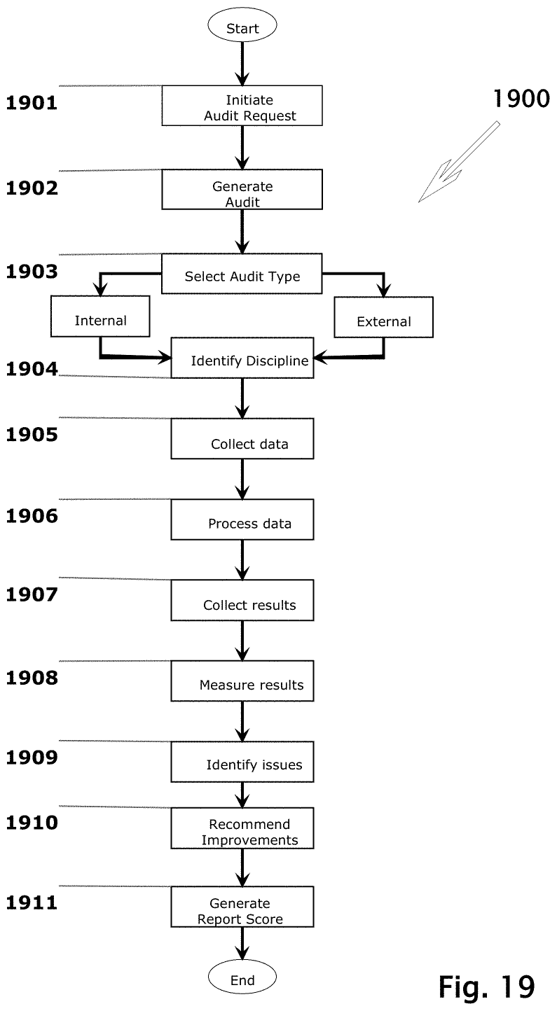

FIG. 19 is a flow diagram 1900 illustrates the automated auditing process of the project, in which an auditor can pull the necessary documents, collect data, and measure results. It also, illustrates a feature of identifying issues and recommending corrective or improvements. The automated auditing process of the project, in which an auditor can pull the necessary documents, collect data, and measure results. It also, illustrates a feature of identifying issues and recommending corrective and/or improvement actions. All as stated in FIG. 19 and as shown in 1901, 1902, 1903, 1904, 1905, 1906, 1907, 1908, 1909, 1910 and 1911.

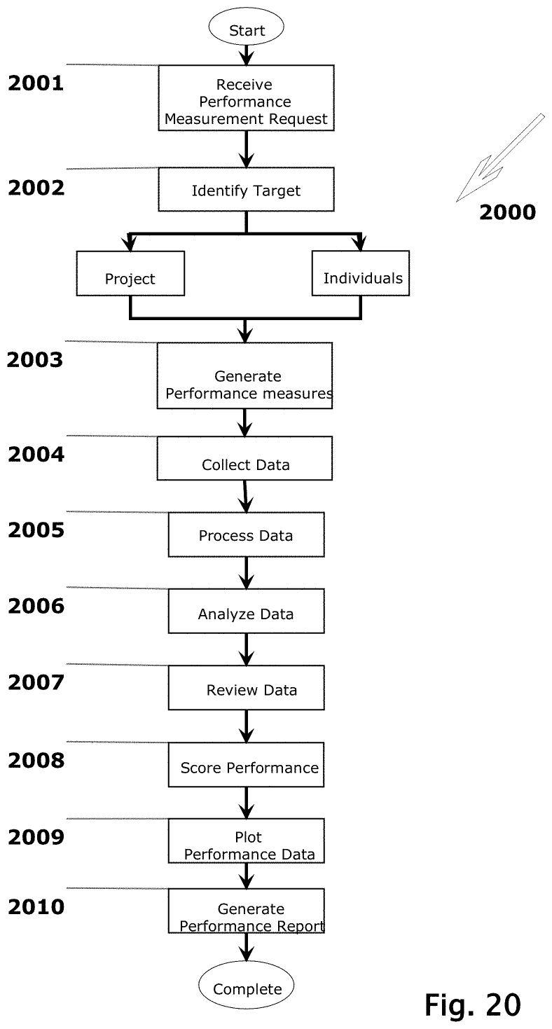

FIG. 20 is a flow diagram 2000 represents the performance measurements based on the preset performance indicators for both the project and the individuals working on the project. All as stated in FIG. 20 and as shown in 2001, 2002, 2003, 2004, 2005, 2006, 2007, 2008, 2009 and 2010.

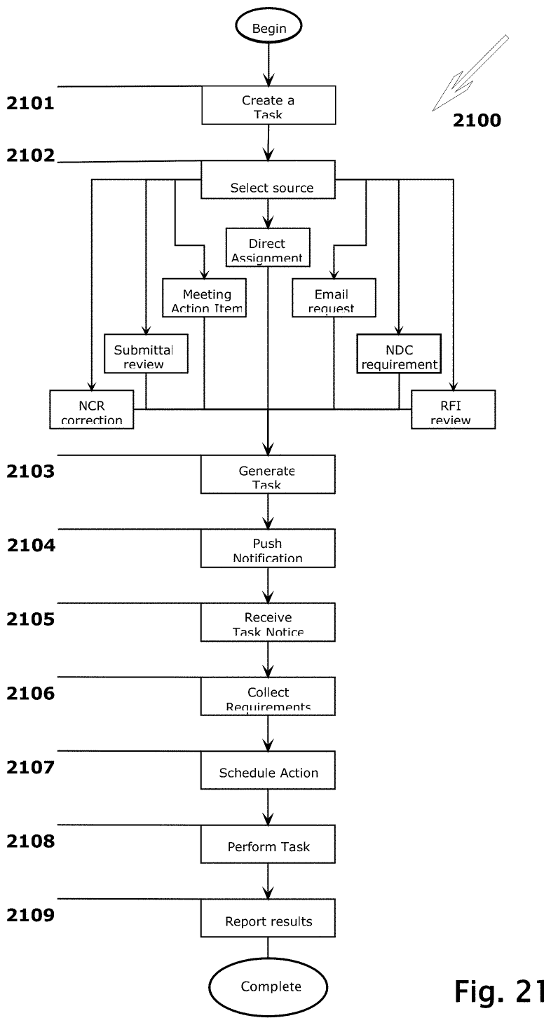

FIG. 21 is a flow diagram 2100 represents task management, it illustrates how managers can assign tasks to users and from different approaches, because of meeting action items, email assignment, direct assignment or other and at the same time it reflects how user will be digitally notified with these assignments and act on each one of them in a timely manner. The result of these tasks is documented and communicated with the issuer on a real time basis. The task management illustrates how managers can assign tasks to users and from different approaches, as a result of meeting action items, email assignment, direct assignment or other and at the same time it reflects how user will be digitally notified with these assignments and act on each one of them in a timely manner. The result of these tasks is documented and communicated with the issuer on a real time basis. All as stated in FIG. 21 and as shown in 2101, 2102, 2103, 2104, 2105, 2106, 2107, 2108 and 2109.

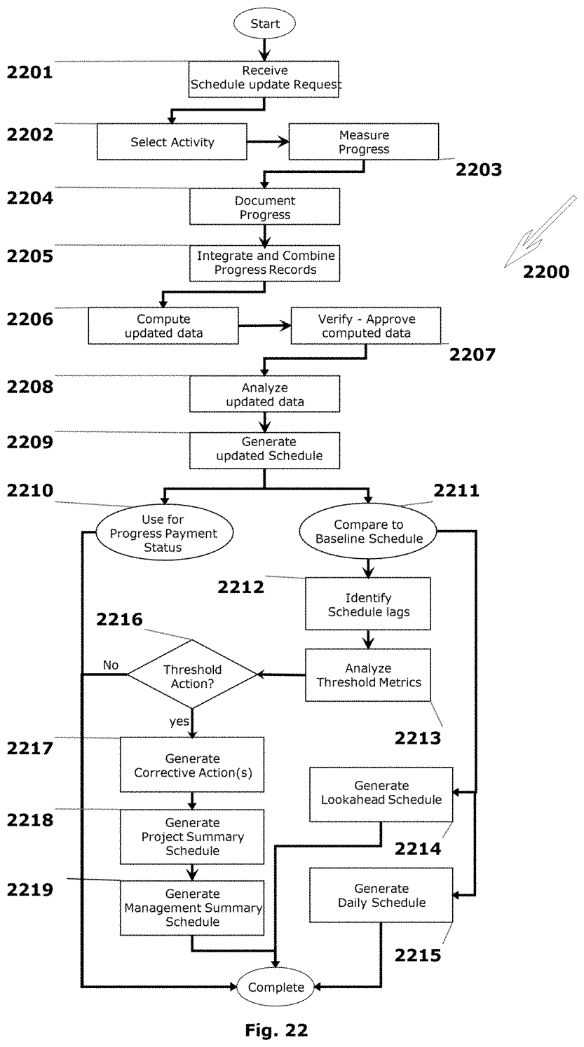

FIG. 22 is a flow diagram 2200 represents schedule monitoring process and provides actual schedule progress and updates at any point in time during execution, construction. The look ahead schedules and daily work schedules can be generated with more accurate data. The look ahead schedules can also be used with the emergency mapping program to use the GPS locations for the physical locations of the project and manpower. Measuring actual project's progress and performance based on the earned values, activities duration and/or commodity helps management to better evaluate the status of the intermediate and completion milestones of the project to take an action while approaching project's thresholds. This method provides the tool to document actual work completed, update the remaining work schedule to reflect current work plans and regularly provide the data necessary to measure progress. Filed engineers and inspectors provide construction progress and status while doing their typical day-to-day work. Such progress status information (percentages) automatically propagates to the schedule update and the monthly progress payment application. In an event that delay or float time erosion, the system automatically notifies management with the affected work element and enhances for real time corrective action. In an event critical activity work item is affected the system automatically alerts management and effected team to assess the situation and to provide quick corrective action and to prevent project delays. Because of the automated and real time documentation, both cases either related to float erosion or to critical activity impact the root cause of the problem is automatically identified and an immediate corrective action can be provided. As shown in blocks 2201-2219.

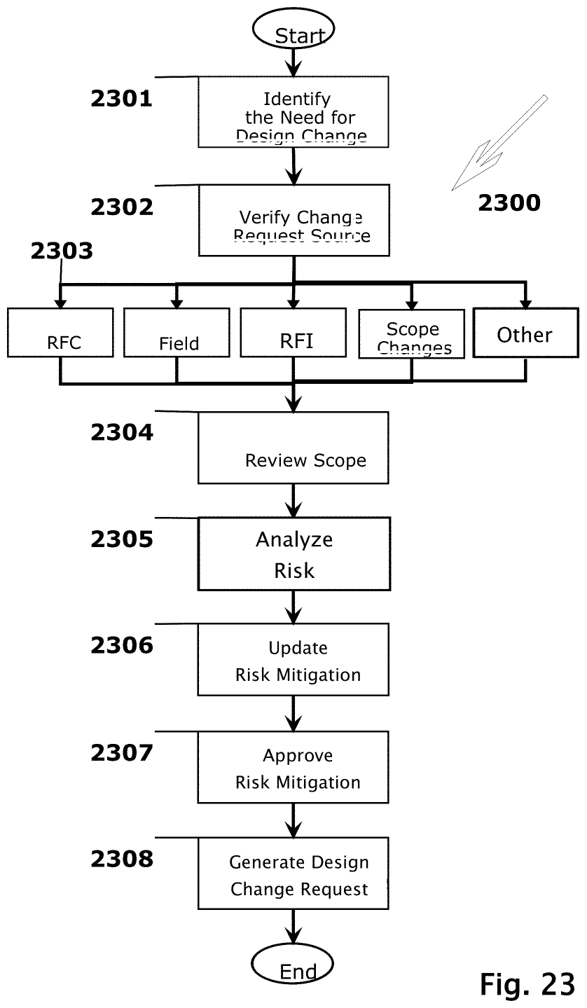

FIG. 23 is a flow diagram 2300 illustrates the Notice of Design Change (NDC)—of the project, such change may be initiated due to field conditions, a Request for Information (RFI) disposition, scope change, additional scope, an in-complete or unclear project plan or due to any other reason. This figure with the processes from 2301 through 2308 identifies the automated actions to be taken to initiate the design change request. Such process keeps all field and other project's individuals aware of the construction status of any element on the project which eliminates any confusion related to project plans and prevents continuation on an error. Ultimately, the new design will be incorporated in the system ready for execution—construction. This feature prevents errors and eliminates disputes and un-necessary removal which saves the project cost and time. As shown blocks 2301-2208.

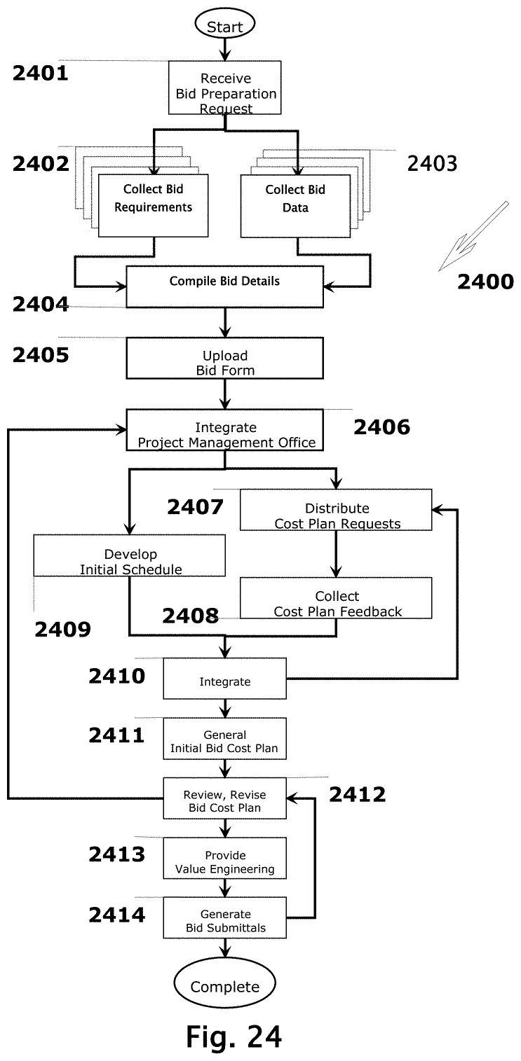

FIG. 24 is a flow diagram 2400 presents the automated bidding process and procedures, this incorporated feature in the system allows users at the member level to generate bid submittals including all required bid preparations that is not limited to take off and developing the initial preliminary schedule of the project. Integrated cost loaded activities allow members to bid for the projects more accurately and prevents potential errors. This feature allows member's users to identify and estimate material, resources, equipment and time for all scope items and identifies all other work that is not in the scope at an early stage. Quality control and quality assurance costs and time are part of this feature, in which member can budget adequate cost for this work and allocate reasonable time too. This feature carries bidding from initiation to closeout and acceptance, all depends on how detailed and accurate the project schedule may be. Project's Management Office database plays a major rule in this feature and allow members to benefit from the pre-loaded activity unit cost database. The feature are shown and described in blocks 2401 through 2414 that allow for unit costs as well as time and material activities; in which can be used not only during bidding time but for the work changes while executing the project.

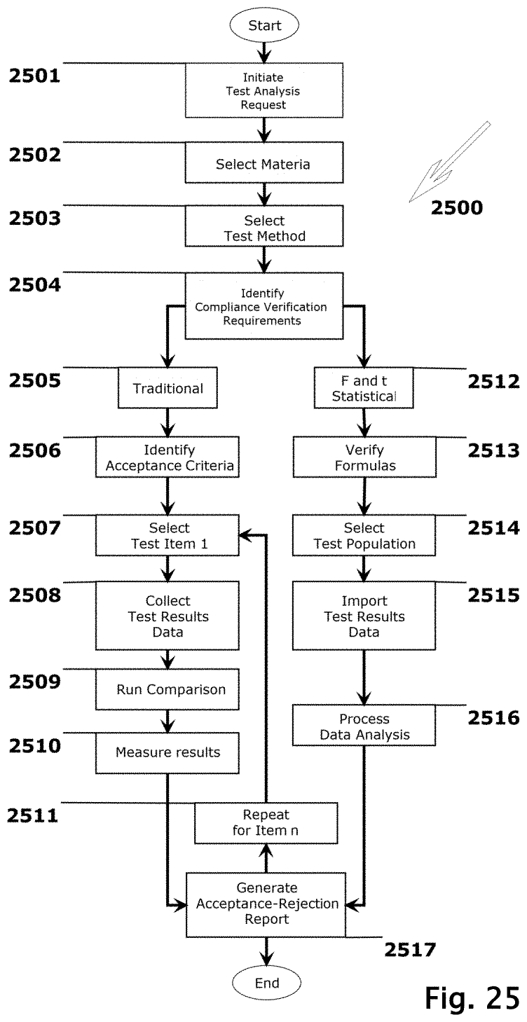

FIG. 25 is a flow diagram 2500 provides the materials tests compliance and verifications for quality acceptance. The system provides two methods for material testing and acceptance; the Traditional which based on tolerances and the Statistical F and t analysis based on the standard deviation variances. User can select either method or can compare acceptance criteria by running same test results utilizing both methods. User's test results may be generated and input from the field or from any or all approved project's laboratories in which QC, QA and third-party verifier's data can be compared and utilized for acceptance criteria. The process steps are shown and described in blocks 2501 through 2517.

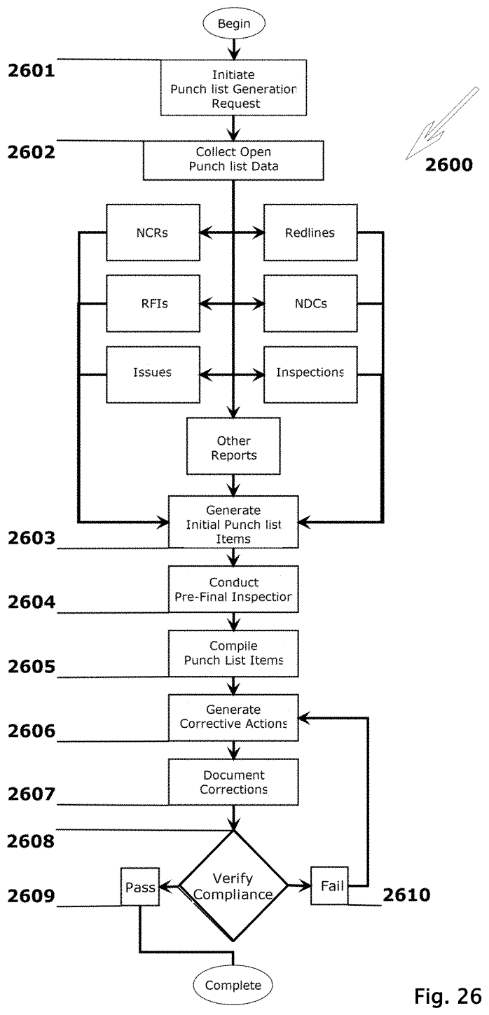

FIG. 26 is a flow diagram 2600 representing punch list items of the project, process steps from 2601 through 2610 are self-explanatory and state the capability of this disclosed invention to generate and provide punch list items at any time of the project. Such capability allows for real time corrections without impacting the level of quality and/or the project schedule. In addition, this capability and feature allows to achieve the highest possible quality levels and prevents potential delays, claims and/or rejection of any item of the project. At the work completion of each element, field engineers, QC and QA (validators and verifiers) along with the owner's representatives can inspect, capture, and generate punch list items. All the potential open punch list items from the project during execution are the miscellaneous and minor items; while the pre-final and the final inspection reports punch list items will be added to the initial punch list items for corrections. All punch list items are automatically categorized per discipline, design package, element, and location. This disclosed invention allows for an automated notifications concerned individuals to plan and execute corrective actions. Alerts and reminders are automatically sent to those in charge to act on timely manner to prevent and delay or impact on the project. This process is repeatable until all punch list items are corrected and/or disposed.

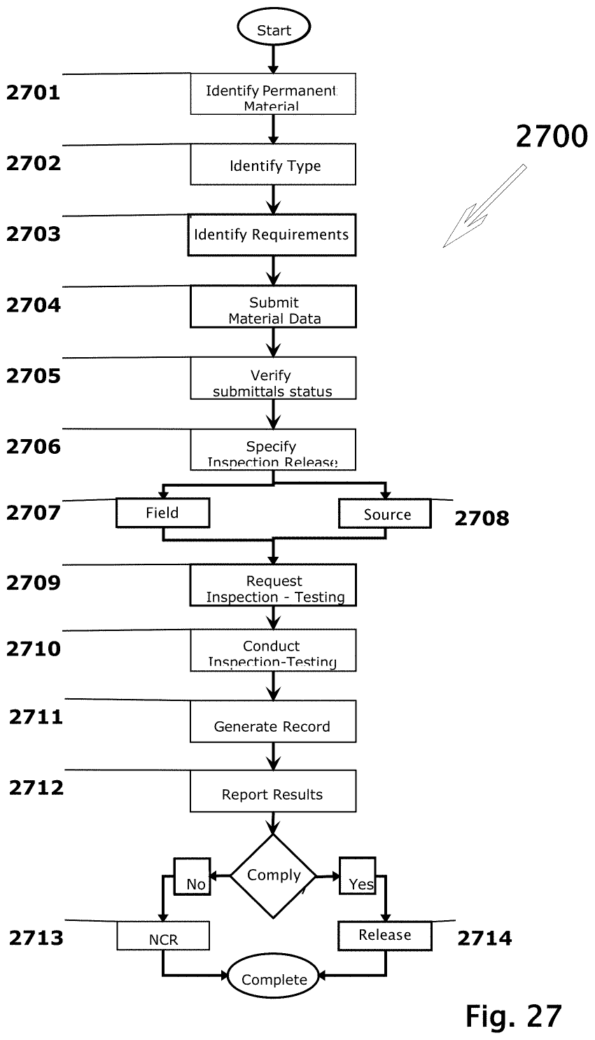

FIG. 27 is a flow diagram 2700 clarifies material testing process and procedure in this disclosed invention method. These material tests can be generated at the field and/or at the sources for thorough technical and quality verification on a real time manner. Such feature in the disclosed invention allows the vendors, the quality testers and verifiers to communicate and to conduct such work in a fully automated and shared environment. This capability allows the project management to monitor and track permanent material status on time and to prevent potential disputes and/or delays. Such real time data process enhances the need to generate material acceptance-rejection reports on timely manner which allows for faster release of passing materials. The automated process steps are as shown and described in blocks 2701 through 2714.

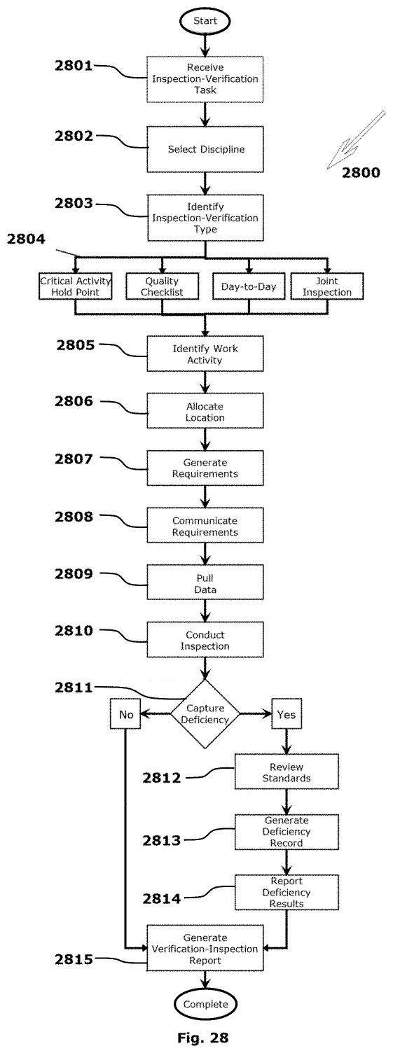

FIG. 28 is a flow diagram 2800 illustrates the automated inspection and verification process provided in this invention. Critical Activity point of Inspection—Hold Point, Typical Quality Check lists, Joint inspections or day-to-day quality control, quality assurance and/or quality verifiers on the project. By means of this invention method and features, inspection reports can be automatically conducted at the field or at the source. Based on the work breakdown structure of the design—execution packages of the project, inspectors develop reports by capturing the lowest activity level available in the schedule which allow for thorough and accurate documentation and retrieval of specific data on a real time at any time of the project. After approval, office users can access, review, analyze and report on any of these reports or their contents. Such capability provides actual; project's timeline for the management and answers all questions may be generated by quality, construction, control, contracts, or any of the project management team. This process method steps are as shown and described in blocks 2801 through 2815.

The preferred embodiments of these systems and methods will be illustrated in this invention by utilizing the design-build (DB) procurement of the construction project management as an exemplary module. Such an industry has been chosen due to its complexity while this invention provides complete solutions to conduct typical program or project management tasks from initiation to closeout.

Although, the management of construction projects is very dynamic and classified as the most diversified and complex industry to manage, especially when it comes to mega infra structure projects this program allows for real time data update and sharing among all stakeholders; such depends on and based on the pre-authorized access privilege to each user. This disclosed invention resolves the problem of construction diversification and complexity and decreases the risk based on the procurement and delivery systems of these projects.

All presented data of this disclosed invention are clear enough to those individuals of the industry to understand the configuration, parts, modules, packages, and elements. Components, connectivity, and the setup of all elements along with the sequence of this invention was clarified too. This invention is not limited in its application to the details and the components arrangements. The invention can be presented in so many ways with other embodiments and how being practiced or being carried out in various ways. What is presented in this invention is just to clarify in a direct and simple way the entire structure of the invention along with its specific modules and packages that provide a complete solution for the management industries regardless of the specific discipline. The phraseology and terminology used herein are for the purpose of providing easy and direct description of the invention parts/tiers, components, modules, packages, and elements, such should not be regarded as limited.

Thus, specific embodiments of a computer program/project management solution have been disclosed. It should be apparent, however, to those skilled in the art that many more modifications besides those described are possible without departing from the inventive concepts herein. The inventive subject matter, therefore, is not to be restricted except in the spirit of the appended claims.

1. A cloud-based computer implemented product that integrates group functions of a project comprising:
a project management dashboard system having a bidding process;
an initial setup that defines a project, a project procurement type and at least one member's role of said bidding process;
said project management office includes entering and tracking project execution of project plans, templates, forms, tables and technical support;
said project management dashboard system provides support after project completion, a project punch-list and a closeout;
an emergency mapping program that links a global positioning location (GPS) of at least one global location of said project and global positioning location of a GPS activated cell phones, laptops, desktop computers and tablets of said at least one member;
contracts and change management solution, wherein said contracts and procurement management;
change management; directive letters; stop work orders; validation correspondences; differing site conditions; liquidated damages; labor compliance; disputes and potential claims management; complaints and public feedback; sub-contracts are tracked and managed through said dashboard system from office and field work environments in which at least one potential change order is generated, reviewed and submitted for further contractual actions;
at least one contractual change is identified and flagged in said dashboard system as a potential change and is tracked based upon a situation and a type of pay agreement;
a meetings management, that develops, assigns and acts on tasks and assignments; communicating through emails and messaging; business collaboration; transmittals and correspondences; providing features that manage business processes; customize business needs to preferred formats; link member's organization to preferred leads; manage-mail-in mail-out; customize routing of business process; access organization's projects; monitor and track performance; provide required back-up for organization's projects; track and record project's lessons learned;
said dashboard system continually records, and updates changes to said project to said dashboard system including;
documenting and reporting meeting minutes and actions taken;
generating specific action items for specific individuals, due on specific date;
follow-up on tasks, action items, reporting results and publishing;
a progress monitoring that tracks scheduling, timelines and milestones;
a performance measurement for the project, including materials and individual;
an auditing to conduct and facilitate project training;
a track project completion and closeout on a project progress basis, and
a reporting system, wherein at least one technical or non-technical report is generated, reviewed and approved including a traffic handling, a management plan whereby traffic managers review, approve and request closure to obtain agency approval for traffic control and closures reporting and a public outreach management that allows public to search and view project's general information including alerts and progress status wherein said alerts include generation of at least one of text message, phone call or email based upon an alert setting in said dashboard system for said at least one member.

2. The cloud-based computer implemented product that integrates group functions of a project according to claim 1, wherein the project management dashboard system is pre-loaded on the computer readable database;
while in a pre-bid phase the project management dashboard system further includes a project setup with a general and/or specific—project administrator platforms with the project procurement type to choose and select a project's procurement packages based on its delivery type;
a rule on the project configured selects a member's rule package on the project as an owner, a builder, a designer, a quality manager, an oversight and a consultant;
upon selection of the project's procurement package, a project initial information configures to setup a project initial information including general data and said project's specifics from a request for project proposal (RFP), and insurance, bid-bonds are configured to procure and select insurance and bonds requirements that track and report said project's performance;
project preparation, project initiation, planning and initial project set up includes creating, modifying or update project management plans templates, collecting project requirements and specifying project's scope, and
initiating and developing project's preliminary schedule, estimate and allocate budgets, initiate work breakdown structure, specifying project activities and estimating resources and durations.

3. The cloud-based computer implemented product that integrates group functions of a project according to claim 1, under project management office functionality and relations further includes;
a meetings management solution;
a Request For Information (RFI) module;
a non-conformance reporting and resolution system;
a punch list capturing and disposition system;
a reporting system;
a change management solution;
an auditing system;
a project performance, progress, and real time status;
a uniform filing system;
a progressive closeout system, wherein
said solutions and systems are provided to facilitate and optimize the functionality by executing computer executable process and procedure that are pre-loaded on the computer readable database.

4. The cloud-based computer implemented product that integrates group functions of a project according to claim 3, further includes a non-conformance reporting and notice (NCs).

5. The cloud-based computer implemented product that integrates group functions of a project according to claim 3, further included a request for information (RFI) management system and module.

6. The cloud-based computer implemented product that integrates group functions of a project according to claim 3, further includes a progressive closeout system.

7. The cloud-based computer implemented product that integrates group functions of a project according to claim 1, further includes;
said auditing system, wherein
at least one auditing for at least one type of the management categories is conducted, reported, reviewed, analyzed and provided a recommended improvement action;
and further includes a self-auditing program that identifies project success and failing areas.

8. The cloud-based computer implemented product that integrates group functions of a project according to claim 1, further includes;
a uniform filing system, wherein all project's files and folders are categorized in said uniform filing system;
such filing system provides a fit for use module on all management disciplines and allows for accurate documents and records repository;
said records repository is accessible online;
open to all users based on their access privilege;
said uniform filing system contains all necessary categories as per the agencies pre-approved document management systems, and
said pre-approved document management systems is subject for additions and editing within a pre-set and pre-defined filling categories.

9. The cloud-based computer implemented product that integrates group functions of a project according to claim 1, under project management office work phases further includes;
a support organizational general administrator during all day-to-day operations of project construction;
a pre-bid operations and setting up new projects;
providing updated information that supports the bidding process;
allowing for advance project setup and maintaining and updating project data;
supporting project completion and closeout;
providing standardized and customizable process and procedure through project acceptance, commissioning and operation, and
said solutions and systems are provided to facilitate and optimize functionality by executing computer executable process and procedure that are pre-loaded on the computer readable database;
said solutions and systems include progressively managed;
at least one inspection, at least one and said reporting system;
a critical activity point of inspection, at least one hold point, and at least one report on said critical activity point of inspection;
an open to service completion report for use during construction and an open to the public report;
a work completion report that starts a punch list inspection;
a work completion inspection report after said punch list inspection is complete;
a work completion acceptance report when all permanent work of a project is completed and accepted, and
a project completion and acceptance report for a final project completion and acceptance.

10. The cloud-based computer implemented product that integrates group functions of a project according to claim 1, further includes a safety and crises management plans that uses said GPS location with said emergency mapping program to identify said at least one member that is affected by an unscheduled disruption in said project.

11. The cloud-based computer implemented product that integrates group functions of a project according to claim 1, further includes an environmental management and stormwater pollution prevention plans.

12. The cloud-based computer implemented product that integrates group functions of a project according to claim 1, further includes a materials engineering and construction inspection and testing plans.

13. The cloud-based computer implemented product that integrates group functions of a project according to claim 1, further includes risk management that includes risk identification, risk analysis and risk mitigation.

14. The cloud-based computer implemented product that integrates group functions of a project according to claim 1, wherein said alert includes an alert acknowledgement that is time and date stamped when the alert is acknowledged.

15. The cloud-based computer implemented product that integrates group functions of a project according to claim 10, wherein said emergency mapping program uses a map on said at least one members GPS activated cell phones, laptops, desktop computers and tablets that provides a visual image of affected area.

16. The cloud-based computer implemented product that integrates group functions of a project according to claim 15, wherein said emergency mapping program provides GPS locations of all said members and said map includes a map outline area of affected that is alterable to change notification of said member(s).

17. The cloud-based computer implemented product that integrates group functions of a project according to claim 10, said dashboard includes a setting for said computer implemented product to send notifications.

18. The cloud-based computer implemented product that integrates group functions of a project according to claim 17, wherein said setting for sending notifications includes a notification type including a text message or an alert.

19. The cloud-based computer implemented product that integrates group functions of a project according to claim 18 further includes a mute alters function.

20. The cloud-based computer implemented product that integrates group functions of a project according to claim 10, further includes traffic closure management, motorist's information plan, maintenance of traffic information, traffic flow and law enforcement service of roads and highways.
